(19) United States
(12) Patent Application Publication
(10) Pub. No.: US 2018/0265987 A1
(43) Pub. Date: Sep. 20, 2018

(54) WEAR RESISTANT SLURRY HANDLING EQUIPMENT

(71) Applicant: GENERAL ELECTRIC COMPANY, Schenectady, NY (US)

(72) Inventors: Fabio D'INTRONO, Bari (IT); Todd C. CURTIS, Guilderland, NY (US); Carlo DEL VESCOVO, Bari (IT); Dennis Michael GRAY, Niskayuna, NY (US)

(21) Appl. No.: 15/321,380

(22) PCT Filed: Dec. 11, 2015
(86) PCT No.: PCT/IB2015/002380

§ 371 Date: Dec. 22, 2016

(51) Int. Cl. C23C 28/00; C23C 4/10; F04D 29/42

(52) U.S. Cl. CPC C23C 28/324; C23C 4/10; F04D 29/4286; F05B 2280/2007; F05B 2260/95; F05B 2280/6011; F05B 2280/2008; F05B 2230/90

(57) ABSTRACT

A method of protecting slurry handling equipment is presented which involves (a) identifying one or more types of wear events (erosion, abrasion, corrosion) to which a surface of the slurry handling equipment is susceptible during operation; (b) estimating the severity of each type of wear event the surface will experience during operation; and (c) applying one or more of a thermal spray coating comprising a metal carbide or a metal nitride, and an erosion resistant organic coating to the surface. The types and severity of the wear events are predicted using one or more computational fluid dynamics models, and the application of either or both of the thermal spray coating and the erosion resistant organic coating to the surface is predicated on the types of wear events identified and their estimated severity. In addition, slurry handling equipment and components thereof protected using the method are provided.

### BACKGROUND

The subject matter of this disclosure relates to wear resistant equipment useful for processing slurries. In a particular aspect, embodiments disclosed herein relate to wear resistant equipment useful for processing slurries such as those encountered in mining operations.

Slurry handling equipment, such as slurry handling pipelines and constituent pumps and valves, is an important component of modern mining operations. The slurries involved may be essentially mineral feedstock to be processed into a refined mineral, or may be a waste stream produced in a mining or ore refining operation. Slurries produced in such mining related operations may be highly abrasive and may be highly acidic or highly basic. As such, slurry handling equipment may be damaged by contact with a slurry being processed by such equipment and require repair or replacement at relatively short intervals. That many mining operations are carried out in remote locations under extreme climatic conditions increases the economic burdens attending equipment remediation in the field. As a result, there is a need to provide slurry handling equipment and equipment components having enhanced operational life, and to provide such equipment and components in a cost effective manner.

### BRIEF DESCRIPTION

In a first aspect of the disclosure, a method of protecting slurry handling equipment is provided. The method includes the steps of identifying one or more types of wear events to which an internal surface of the slurry handling equipment is susceptible during operation, estimating the severity of each type of wear event the surface will experience during operation, and applying one or more of a thermal spray coating comprising a metal carbide or a metal nitride, and an erosion resistant organic coating to the surface. The types and severity of the wear events are predicted using one or more computational fluid dynamics models. The application of either or both of the thermal spray coating and the erosion resistant organic coating to the surface is predicated on the types of wear events identified and their estimated severity.

In a second aspect of the disclosure, a method of protecting slurry handling equipment is provided. The method comprises applying one or more of a thermal spray coating comprising a metal carbide or a metal nitride, and an erosion resistant organic coating to one or more internal surfaces of the slurry handling equipment. The one or more internal surfaces selected for protection are identified as surfaces susceptible to one or more wear events during operation using one or more computational fluid dynamics models. Either or both of the thermal spray coating and the erosion resistant organic coating are applied to the one or more internal surfaces predicated on the types of wear events identified and the estimated severity of such wear events as predicted by the one or more computational fluid dynamics models. The thickness of the thermal spray coating and the thickness of the erosion resistant organic coating required to provide a significant level of protection to the surface with respect to each wear event identified is predicted using the one or more computational fluid dynamics models.

In a third aspect of the disclosure, a slurry handling pump is provided. The pump comprises one or more internal surfaces susceptible to erosion wear events and one or more internal surfaces susceptible to abrasion wear events. One or more protective coatings substantially cover each surface susceptible to erosion wear events and each surface susceptible to abrasion wear events. The protective coatings are selected from one or more of a thermal spray coating comprising a metal carbide or a metal nitride, and an erosion resistant organic coating. The surfaces selected for protection have been identified as surfaces susceptible to erosion wear events and surfaces susceptible to abrasion wear events using one or more computational fluid dynamics models. The protective coatings are selected based on the predicted type and severity of the wear event identified by the one or more computational fluid dynamics models.

In a fourth aspect of the disclosure, a slurry handling apparatus is provided. The slurry handling apparatus includes at least one internal surface susceptible to erosion wear events and at least one internal surface susceptible to abrasion wear events, and a plurality of protective coatings substantially covering each surface susceptible to erosion wear events and each surface susceptible to abrasion wear events. The protective coatings are selected from one or more of a thermal spray coating comprising a metal carbide or a metal nitride, and an erosion resistant organic coating. The surfaces selected for protection have been identified as surfaces susceptible to erosion wear events and surfaces susceptible to abrasion wear events using one or more computational fluid dynamics models. The protective coatings are selected based on a predicted type and severity of the wear event identified by the one or more computational fluid dynamics models.

In a fifth aspect of the disclosure, a component of a slurry handling apparatus is provided. The slurry handling apparatus component includes at least one component surface configured to constitute an internal surface of a slurry handling apparatus susceptible to one or more wear events selected from the group consisting of erosion, and abrasion, and one or more protective coatings substantially covering each component surface susceptible to said wear events. The protective coatings are selected from one or more of a thermal spray coating comprising a metal carbide or a metal nitride, and an erosion resistant organic coating. The component surface selected for protection has been identified as a surface susceptible to the wear events using one or more computational fluid dynamics models. The protective coatings are selected based on the a predicted type and severity of the wear event identified by the one or more computational fluid dynamics models.

### BRIEF DESCRIPTION OF THE DRAWING FIGURES

Reference is now made briefly to the accompanying drawings, in which:

FIG. 1 depicts a schematic diagram of an embodiment of a new slurry handling pump;

FIG. 2 depicts components of a slurry handling pump;

FIG. 3 depicts components of a slurry handling pump;

FIG. 4 depicts a new suction liner component of a new slurry handling pump;

FIGS. 5, 6, 7, 8 and 9 depict a new casing liner component of a new slurry handling pump;

FIGS. 10, 11, 12, 13, 14, 15, 16, 17, 18, and 19 depict a new impeller component of a new slurry handling pump;

FIG. 20 depicts one or more applications employing slurry handling equipment; and

FIG. 21 depicts a method of protecting slurry handling equipment.

Where applicable, like reference characters designate identical or corresponding components and units throughout the several views, which are not to scale unless otherwise indicated. The embodiments disclosed herein may include elements that appear in one or more of the several views or in combinations of the several views. Moreover, methods are exemplary only and may be modified by, for example, reordering, adding, removing, and/or altering the individual stages

### DETAILED DESCRIPTION

This disclosure provides a new method for protecting slurry handling equipment, and slurry handling equipment and components thereof produced using the new method. The new method uses one or more computational fluid dynamics (CFD) models of the equipment in operation to predict the types, locations and severity of wear events to which the equipment will be subject when processing a slurry, and recommends the application of, or actually applies, one or more of a thermal spray coating comprising a metal carbide or metal nitride, and an erosion resistant organic coating to selected equipment internal surfaces the CFD model indicates will be subject to unacceptably high rates of wear. Slurry handling equipment is useful in modern slurry processing operations found in mineral and hydrocarbon production, among others.

As noted, the type and severity of the wear events are predicted using one or more computational fluid dynamics tools (CFD) which models the equipment in operation at a particular service class (i.e. severity of service). Such predictions, made within the framework of a particular slurry handling equipment configuration, may incorporate factors such as the type of slurry to be processed by the equipment (solids in gas versus solids in liquid), the rate of throughput of slurry through the equipment, the particle size distribution of the slurry, the hardness of the slurry particles and the concentration of solid particles in the slurry, among others. Thus, CFD models used according to one or more embodiments take into account the geometries of slurry flow paths through the equipment, the presence of restricted passages and the presence of moving and stationary internal surfaces, as well as the characteristics of the slurry itself to predict, for example, the internal surfaces in the slurry handling equipment most likely to undergo substantial erosion and abrasion wear events during operation. Those of ordinary skill in the art will understand that erosion wear events will occur when slurry particles impinge on a surface of the equipment, and abrasion wear events may be especially severe where a first moving surface moves in close proximity to a second stationary or moving surface in the presence of slurry particles.

While the types of wear events a surface is subject to may at times be inferred from the location of the surface within the slurry handling equipment, the predicted severity of the wear event and its assessment as service life limiting or not, may be determined using the one or more CFD models in advance of the equipment being deployed. A salutary aspect of the method is that the protective measures taken based on the CFD wear event predictions are appropriate to the type and severity of the wear events the targeted surfaces will experience during operation. Efficiencies are realized in that unneeded protective measures are not exercised, and the costs of unneeded protective measures are avoided.

Armed with a foreknowledge of the locations within the equipment most likely to undergo wear events likely to damage the slurry handling equipment while handling a particular slurry type, a practitioner may take appropriate measures to protect surfaces deemed vulnerable, without the need to protect surfaces for which the CFD model predicts acceptable wear levels during slurry handling. Suitable protective measures include the application of one or more of a thermal spray coating and an erosion resistant organic coating to surfaces predicted to undergo significant wear events.

In one or more embodiments, the thermal spray coating comprises one or more metal carbides such as are known to those of ordinary skill in the art. In one or more embodiments, the thermal spray coating comprises a metal carbide discontinuous phase and a metal alloy continuous phase. Suitable metal carbides include titanium carbide, zirconium carbide, hafnium carbide, vanadium carbide, niobium carbide, tantalum carbide, chromium carbide, molybdenum carbide, tungsten carbide, silicon carbide, boron carbide and combinations of two or more of the foregoing metal carbides. Metal alloys suitable for use as the continuous phase of a metal carbide-containing thermal spray coating include alloys containing one or more of cobalt, chromium, molybdenum, copper, nickel, vanadium, and carbon.

In one or more embodiments, the thermal spray coating comprises one or more metal nitrides such as are known to those of ordinary skill in the art such titanium nitride and chromium nitride, for example.

The new method disclosed herein may be used in a wide variety of operations in which equipment internal surfaces may come into contact with one or more slurries. Slurry handling equipment which may be protected according to one or more embodiments includes slurry handling pumps, compressors, fans, expanders, turbines, and valves, among others. In one or more embodiments, the slurry handling equipment is selected from the group consisting of pumps, compressors, fans, expanders, turbines, and valves. In one or more embodiments, the slurry handling equipment to be protected is a slurry handling pump comprising a plurality of internal surfaces susceptible to at least one wear event selected from the group consisting of erosion, abrasion, and corrosion. In one or more embodiments, the slurry handling equipment to be protected is a slurry handling pump comprising at least one internal surface susceptible to erosion and at least one internal surface susceptible to abrasion.

Suitable erosion resistant organic coatings are commercially available and may include one or more materials selected from silicone rubbers, polyurethanes, polyepoxides, phenolic resins, and combinations of two or more of the foregoing material types. In one or more embodiments, the erosion resistant organic coating comprises one or more organic silicone polymers such as are disclosed in U.S. Pat. No. 7,033,673 which is incorporated by reference herein in its entirety. In one or more alternate embodiments, the erosion resistant organic coating comprises one or more organic silicone polymers such as are disclosed in U.S. Pat. No. 8,183,307 which is incorporated by reference herein in its entirety.

In a particular set of embodiments, the erosion resistant organic coating comprises a silanol fluid, such as 3-0134 Polymer available from Dow Corning, an inorganic filler, such as a surface treated fumed silica, and a crosslinking agent. In a particular embodiment the erosion resistant organic coating comprises from about 75 to about 95 percent by weight silanol fluid, from about 3 to about 20 percent by weight fumed silica, from about 2 to about 15 percent by weight crosslinking agent, such as ethyl triacetoxysilane, and a crosslinking catalyst, such as dibutyl tin dilaurate. In one or more embodiments, the erosion resistant organic coating comprises a solvent which assists in the application of the coating but which is removed as the coating cures on the coated surface.

The erosion resistant organic coating may be applied as a liquid, powder or film coating and may be applied by any suitable means such as spraying, brushing, and dip coating. In one embodiment, the erosion resistant organic coating is applied by annealing a film of an erosion resistant organic film substantially covering the surface to be protected.

The coatings deployed to surfaces of slurry handling equipment are applied at thicknesses sufficient to provide a significant level of protection to such surfaces with respect to wear events predicted by the CFD model to be equipment life limiting. By significant level of protection it is meant that slurry handling equipment protected as disclosed herein will outlast an unprotected slurry handling counterpart under the same use regime by a length of time an operator of such equipment would consider significant. In one or more embodiments, the slurry handling equipment protected as disclosed herein is expected to outlast an unprotected slurry handling counterpart by a factor of from about two to about 10 times the life of the unprotected slurry handling counterpart under the same or similar service conditions.

In a first set of embodiments, the thermal spray coating is applied to a surface susceptible to one or more wear events selected from erosion, abrasion, and corrosion at a thickness between about 200 and about 3000 microns. In yet another set of embodiments, the thermal spray coating is applied to a surface susceptible to one or more wear events selected from erosion, abrasion, and corrosion at a thickness between about 350 and about 2500 microns. In yet still another set of embodiments, the thermal spray coating is applied to a surface susceptible to one or more wear events selected from erosion, abrasion, and corrosion at a thickness between about 600 and about 2000 microns.

Similarly, in a first set of embodiments, the erosion resistant organic coating is applied to a surface susceptible to one or more wear events selected from erosion, abrasion, and corrosion at a thickness between about 400 and about 2000 microns. In yet another set of embodiments, the erosion resistant organic coating is applied to a surface susceptible to one or more wear events selected from erosion, abrasion, and corrosion at a thickness between about 500 and about 1500 microns. In yet still another set of embodiments, the erosion resistant organic coating is applied to a surface susceptible to one or more wear events selected from erosion, abrasion, and corrosion at a thickness between about 750 and about 1000 microns.

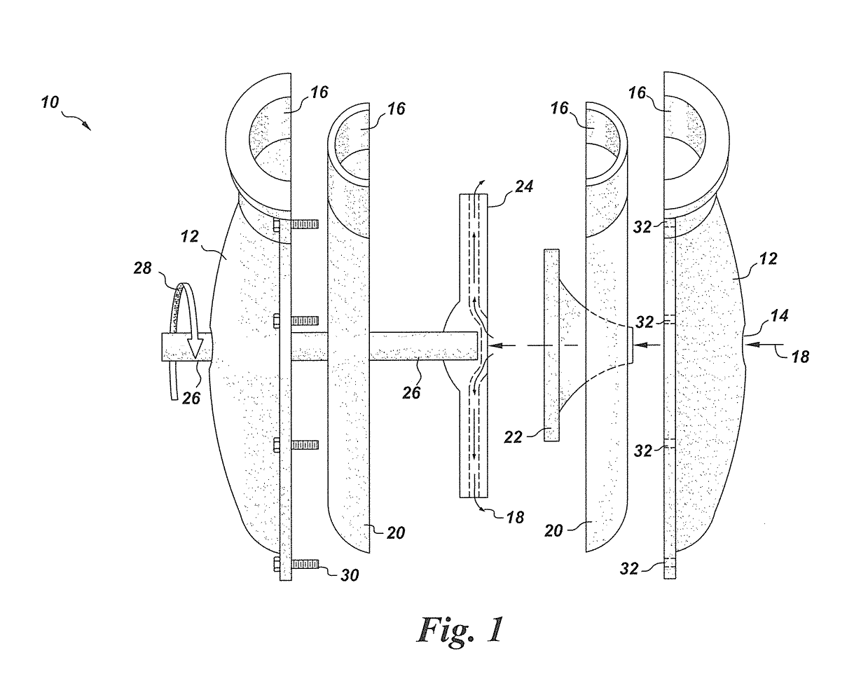

Turning now to the figures, FIG. 1 depicts a new slurry handling pump 10 shown in an exploded view according to one or more embodiments and comprising one or more internal surfaces protected by the method disclosed herein. The pump comprises a pump casing 12, a pump inlet 14, and a pump outlet 16; and defines a slurry flow path 18 between inlet 14 and outlet 16. A casing liner 20 inhibits contact between the inner surfaces of the pump casing and a slurry being processed by the pump. In the embodiment shown the pump casing is made of a metal such as steel and comprises one or more surfaces susceptible to wear events such as erosion and abrasion. The casing liner is selected to be less prone to wear than the pump casing, but may still be susceptible to service life-limiting wear events. In one embodiment, the casing liner is made of a relatively hard thermoset polymer such as rubber. In an alternate embodiment, the casing liner is made of a metal such as steel

Still referring to FIG. 1, the slurry handling pump further comprises suction liner 22 which interfaces with pump inlet 14 at one end and with impeller 24 on the other end. Impeller 24 is powered by drive shaft 26 which is shown as rotating in direction of rotation 28. The entire assembly is held together by bolts 30 which are secured to apertures 32.

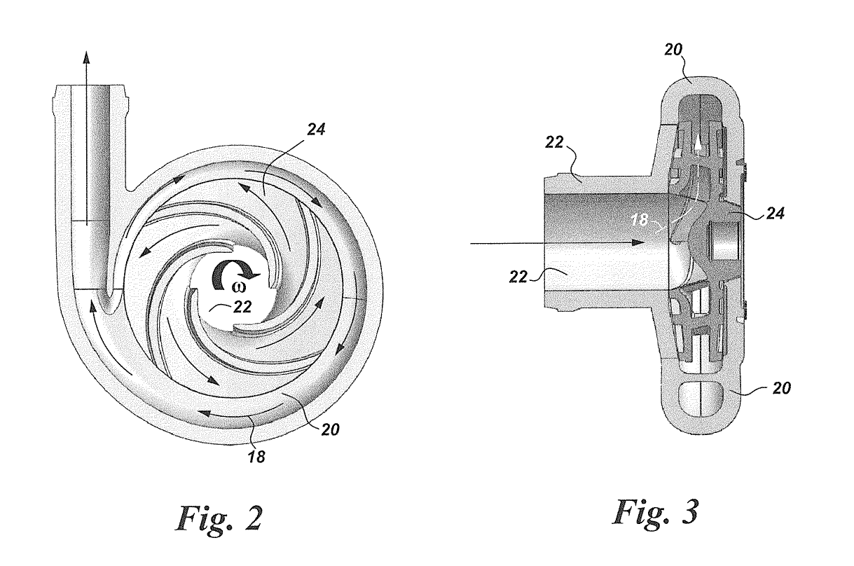

Referring to FIG. 2, the figure represents a cutaway view of slurry handling pump 10 wherein impeller 24 is accommodated by pump casing liner 20. A portion of suction liner 22 is also visible. In the embodiment shown, the observer is looking through the impeller toward the pump inlet.

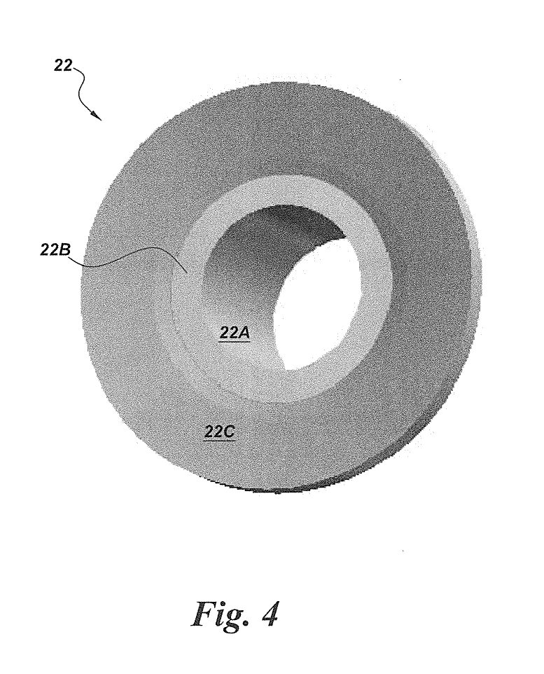

Referring to FIG. 3, the figure represents a cutaway view of slurry handling pump 10 wherein there is a close spatial relationship between the stationary suction liner 22 and the rotary impeller 24. The forward slurry flow path 18 is also illustrated as is casing liner 20.

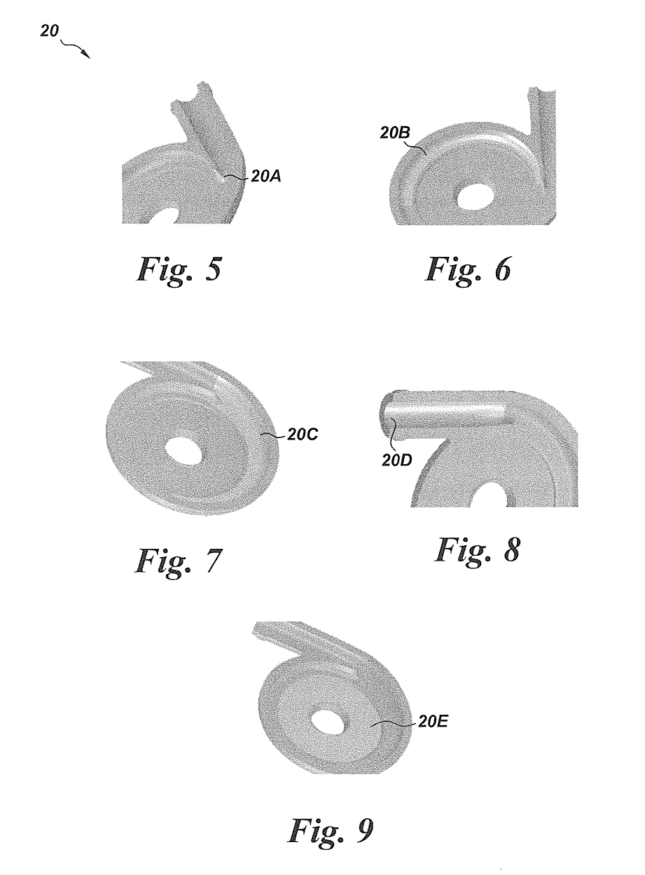

Referring to FIG. 4, the figure represents a slurry handling pump suction liner 22 having three distinct surfaces; surface 22A, surface 22B and surface 22C each of which is susceptible to one or more wear events caused by contact with a slurry being processed by a slurry handling pump comprising such a suction liner. Surface 22A is susceptible primarily to erosion wear events because it is a stationary surface not directly opposite a moving component surface. Stationary surfaces 22B and 22C are each susceptible to both erosion and abrasion because they are directly opposite and are separated by a narrow gap from rotary surfaces of impeller 24. This gap may be larger or smaller based upon the particle size distribution of the slurry to be processed. Typically the gap between these rotary and stationary surfaces is on the order of from about 0.1 millimeter to a few millimeters. FIG. 4 is further discussed in the Experimental Part of this disclosure

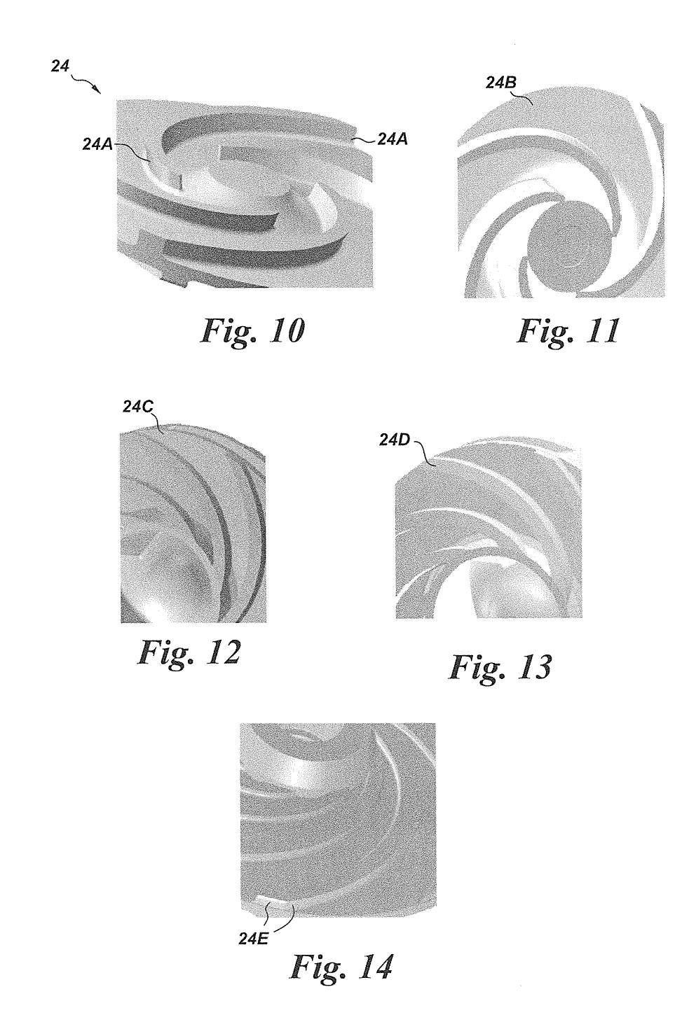

Referring to FIGS. 5, 6, 7, 8 and 9, the figures represent half of a slurry handling pump casing liner 20 having five surfaces 20A, 20B, 20C, 20D and 20E susceptible to one or more wear events. Of these five surfaces only surface 20E (FIG. 9) is predicted by the CFD model to be susceptible to significant levels of abrasion. It is noteworthy that surface 20E is the only surface among the five directly opposite and in close proximity to a moving surface of the impeller. Typically the gap, or tolerance, between stationary surface 20E and the closest rotary surfaces of impeller 24 is on the order of from a fraction of a millimeter to a few millimeters and this gap may be made larger or smaller based upon the particle size distribution of the slurry to be processed. Levels of erosion predicted by the CFD model for surfaces 20A-20D were such that two different types of erosion protection coatings may be advantageously employed; the typically more costly thermal spray coating and the typically less costly erosion resistant organic coating. In one embodiment, each of surfaces 20A-20D may be treated with an erosion resistant tungsten carbide thermal spray coating (inner layer) having a thickness in a range between about 350 and about 2500 microns, and an outer erosion resistant organic silicone coating having a thickness in a range between about 500 and about 1500 microns. FIGS. 5, 6, 7, 8 and 9 are further discussed in the Experimental Part of this disclosure.

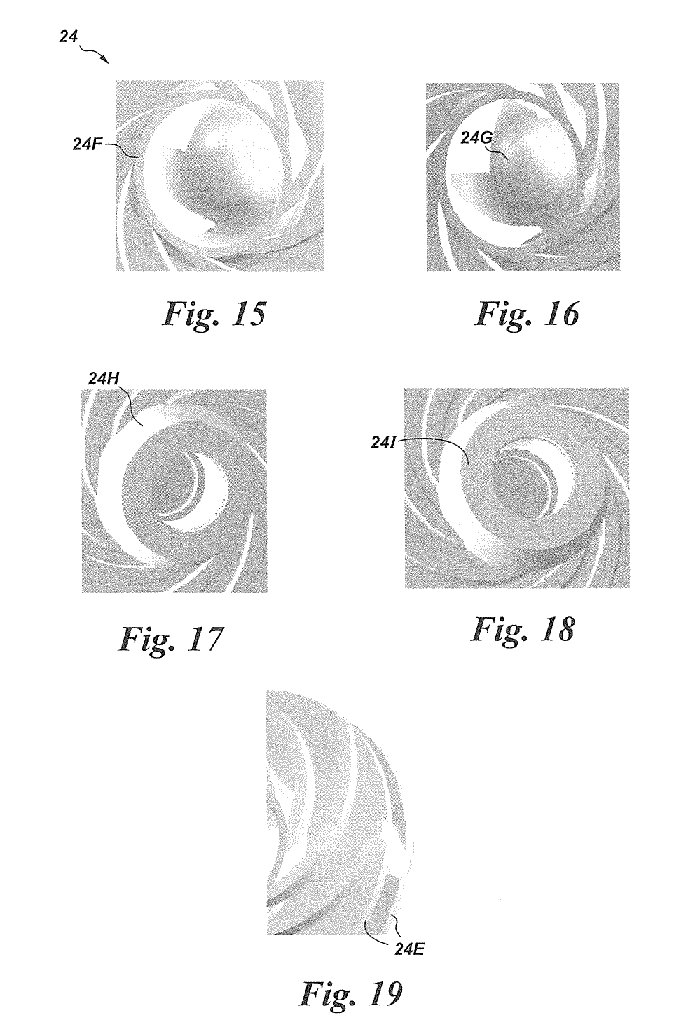

Referring to FIGS. 10, 11, 12, 13, 14, 15, 16, 17, 18 and 19 the figures represent an impeller 24 of a slurry handling pump and its various surfaces (24A-24J) predicted by the CFD model to be susceptible to service life-limiting wear events. Among surfaces 24A-24E, only surface 24D was predicted to be susceptible to both erosion and abrasion service life-limiting wear events. Surfaces 24A, 24B, 24C and 24E were predicted by the CFD model to be subject to differing levels of wear, such that surfaces 24A and 24B may be adequately protected by a single layer of an erosion resistant organic silicone coating depending on the characteristics of the slurry to be processed. Predicted erosion levels at surfaces 24C and 24E were such that a bilayer coating comprising an inner thermal spray coating and an outer erosion resistant organic coating may be employed advantageously.

Surfaces 24F-24J (See FIGS. 15, 16, 17, 18 and 19) of the impeller were predicted by the CFD model to a be subject to erosion-only service life-limiting wear events (surfaces 24G and 24J) and erosion-plus-abrasion service life-limiting wear events (surfaces 24F, 24H and 24I). In each case the protective protocol to be employed is predicated upon the level of wear predicted by the CFD model. FIGS. 10, 11, 12, 13, 14, 15, 16, 17, 18 and 19 are further discussed in the Experimental Part of this disclosure.

FIGS. 4, 5, 6, 7, 8, 9, 10, 11, 12, 13, 14, 15, 16, 17, 18 and 19 illustrate new components of a new slurry handling apparatus which are provided by the disclosure. These slurry handling apparatus components include at least one component surface configured to constitute an internal surface of a slurry handling apparatus, meaning that when the apparatus component is assembled within the completed apparatus, a pump for example, at least one of the component surfaces will constitute an internal surface of the completed apparatus susceptible to one or more wear events selected from the group consisting of erosion and abrasion, and one or more protective coatings will substantially cover each component surface susceptible to said wear events. In one or more embodiments, the protective coating is selected from one or more of a thermal spray coating comprising a metal carbide or a metal nitride, and an erosion resistant organic coating. The component surface selected for protection is identified as a surface susceptible to said wear events using one or more computational fluid dynamics models of the completed apparatus. The protective coatings are selected based on the type of wear events identified by the one or more computational fluid dynamics models, and the severity of such wear events as predicted by the one or more computational fluid dynamics models.

In one or more embodiments, the slurry handling apparatus component may be an apparatus casing, liner, blade, vane, conduit, inlet, outlet, impeller, drive shaft, or valve.

In one or more embodiments, the slurry handling apparatus component comprises an erosion resistant organic coating such as are known to those of ordinary skill in the art. In one or more embodiments the erosion resistant organic coating comprises an erosion resistant silicone elastomer.

In one or more embodiments, the slurry handling apparatus component comprises a thermal spray coating comprising a metal carbide or a metal nitride. Such thermal spray coatings are known to those of ordinary skill in the art and are discussed herein.

In one or more embodiments, the slurry handling apparatus component comprises both an erosion resistant organic coating and a thermal spray coating. In one or more such embodiments, the erosion resistant organic coating comprises a silicone elastomer and the thermal spray coating comprises a tungsten carbide discontinuous phase and a cobalt-chromium (CoCr) continuous phase.

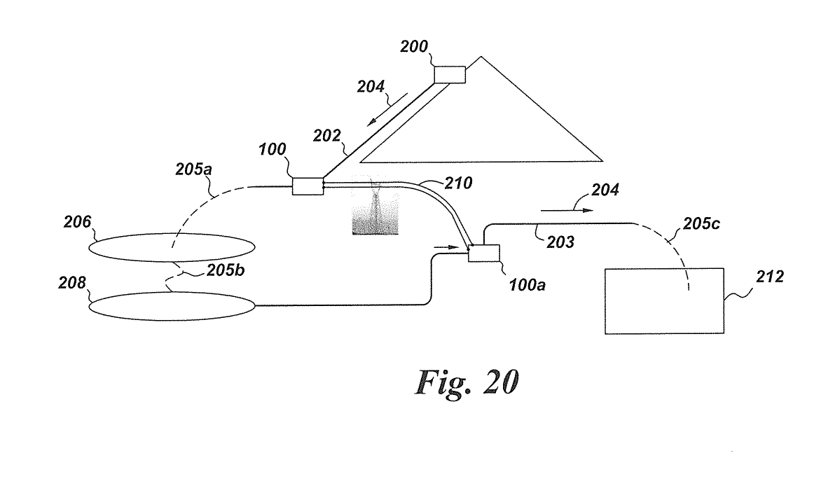

Referring to FIG. 20, the figure represents a system and its application in a mining operation. The system comprises a plurality of slurry handling pumps; a first slurry handling pump 100 configured to serve as a source of mechanical or electric power and a second slurry handling pump 100a configured to process a slurry. A slurry source 200 located at an elevation higher than the first slurry handling pump 100 is fluidly linked via a fluid conduit 202 to the first slurry handling pump and slurry collection pond 206. A primary slurry 205a, for example an ore slurry from a copper mining operation moves in direction 204 under the influence of gravity from the higher elevation slurry source through the slurry conduit and encounters the first slurry pump 100 which is configured to use the kinetic energy of the flowing primary slurry to generate mechanical energy which can be used to drive an electrical generator or another mechanical device. The primary slurry causes the impeller 24 to rotate and this in turn sets the drive shaft 26 in motion. The mechanical energy of the moving drive shaft can be used to drive other equipment such as pumps and generators. In some embodiments, the slurry handling pump is equipped with a permanent magnet motor. Under such circumstances, the slurry handling pump itself can be used to generate electricity when operated in this reverse sense. In the embodiment shown, electrical energy is generated using the mechanical output of the pump being driven by the primary slurry 205a flowing under the influence of gravity. This electrical energy is transferred via electric power link 210 and is used to drive second slurry handling pump 100a which pumps tertiary slurry 205c via fluid conduit 203 to a concentrated slurry destination 212, for example a rail car or a continuous filtration operation. Tertiary slurry 205c is generated from the primary slurry as the primary slurry is introduced into the first slurry pond 206 and is transferred as secondary slurry 205b into second slurry pond 208. The tertiary slurry may have the same or different chemical and physical characteristics as/than slurries 205a and 205b. Differences in slurry characteristics may result from particle concentration changes, the addition chemical adjuvants to slurry ponds 206 and/or 208, and the like.

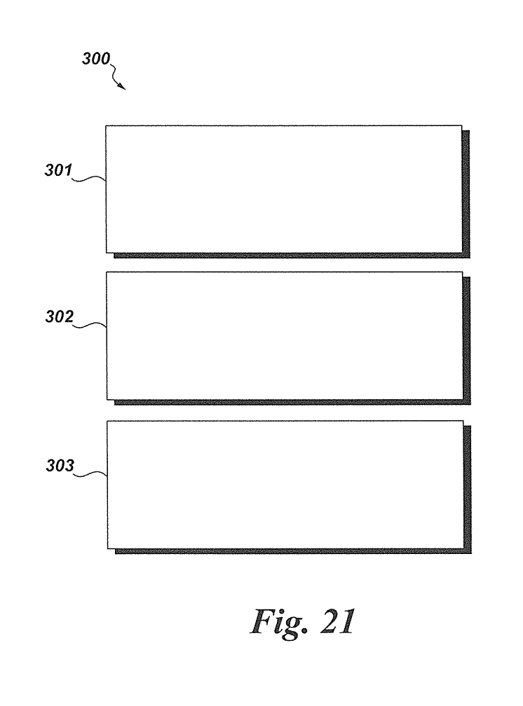

Referring to FIG. 21, the figure represents a method 300 for protecting slurry handling equipment. In a first method step 301, the method comprises predicting one or more types of wear events to which an internal surface of the slurry handling equipment is susceptible during operation using one or more computational fluid dynamics models. In a second method step 302, the method comprises estimating the severity of each type of wear event the surface will experience during operation using one or more computational fluid dynamics models. In a third method step 303, the method comprises applying one or more of a thermal spray coating comprising a metal carbide or a metal nitride, and an erosion resistant organic coating to the surface predicated on the types of wear events predicted and the estimated severity of such wear events.

In practice, the operation of method steps 301-303 produces slurry handling equipment in which surfaces susceptible to wear by contact with the slurry; erosion, abrasion and corrosion, have been identified and selectively protected.

### EXPERIMENTAL PART

An erosion model of the slurry handling equipment, in this instance a slurry handling pump configured as in FIGS. 1-19, was created the using ANSYS computational fluid dynamics (CFD) simulation software tool commercially available from ANSYS, Inc. Canonsburg, Pa. (USA). Parameters used in identifying the types and severity of wear events within the slurry pump included the materials of construction of surfaces susceptible to contact with the slurry (wall materials), particle impingement angle, particle velocity, particle size and particle density.

A 3-dimensional, two-phase flow numerical simulation based on Eulerian-Lagrangian methodology was performed using the ANSYS CFX analysis system to numerically solve the set of discretized Navier-Stokes equations for mass, momentum and energy, while accounting for viscous shear. A representative solid particle size was used in the simulation of slurry flow and for wear rate evaluation. Experimentally measured characteristics of the slurry type to which a slurry handling pump will be exposed may be used advantageously to better predict the types, severity and locations of wear events within the pump. The computational fluid dynamics model provided as outputs wear rates expressed as volume loss per unit time at locations throughout the slurry handling pump. The relative severity of the wear events was estimated by comparing computed wear rates at various locations within the pump. The predicted severities of wear events were in turn used to estimate the type and thickness of protective coatings needed at locations within the slurry handling pump the model indicated were susceptible to service life-limiting wear events.

Components of a slurry handling pump; the suction liner (FIG. 1, numbered element 22), the casing liner (FIG. 1, numbered element 16) and impeller (FIG. 1, numbered element 24), were selected for evaluation. The type and severity of wear events were predicted for eighteen different internal surfaces of these pump components and surface protection protocols were identified and evaluated based on the type and severity of the wear events predicted for a given surface by the model. Each of the surfaces identified may be coated with one or more of a thermal spray coating comprising a metal carbide or a metal nitride having both erosion and abrasion resistance, and an erosion resistant organic coating. Specific coatings and combinations of coatings which may be employed are gathered in in Tables 1-4. The thermal spray coating, such as tungsten carbide (WC) in a cobalt-chromium (CoCr) matrix, may applied by a standard high velocity air fuel thermal spray (HVAF) technique, for example. In one or more embodiments, the erosion resistant organic coating may be an erosion resistant elastomeric silicone coating such are known in the art, and may be applied using known paint spray technology. A thin primer layer approximately 1 mil thick may be applied followed by the erosion resistant organic coating. Primer coatings suitable for use with elastomeric silicone coatings are known in the art and are available commercially from Momentive, Inc., Waterford N.Y. The erosion resistant organic coating may be applied in layers to prevent dripping or sagging of the coating on complex surfaces. Under such circumstances, each layer may be partially cured before then next layer is added. Both the primer and elastomer may be applied and cured at room temperature. The tungsten carbide coating may be applied to the surfaces indicated in Tables 1-4 at coating thicknesses ranging from 350 microns (μ) to 2500μ, and the erosion resistant silicone coating may be applied at coating thicknesses ranging from 500μ to 1500μ. On some surfaces identified as requiring protection from erosion, one or both of the thermal spray and the erosion resistant organic coating may be applied. On other surfaces, where the model predicted significant levels of both abrasion and erosion, the thermal spray coating alone should be employed unless the erosion resistant organic coating is sufficiently abrasion resistant. Where both the thermal spray coating and the erosion resistant organic coating are to be applied, the coatings may be applied in sequence such that the erosion resistant organic coating is applied to the outer surface of the thermal spray coating.

TABLE 1
Predicted Wear Events and Protective Coating
Protocol in Surry Pump Suction Liner

| | See | Predicted | | Coating Thickness |
|---|---|---|---|---|
| Surface | FIG. | Wear Event(s) | Coating(s) | Prescribed |
| 22A | FIG. 4 | Erosion | silicone | 500-1500μ |
| | | | WC | 350-2500μ |
| 22B | FIG. 4 | Erosion & | WC | 350-2500μ |
| | | Abrasion | | |
| 22C | FIG. 4 | Erosion & | WC | 350-2500μ |
| | | Abrasion | | |

Laboratory results employing test coupons treated with the silicone and tungsten carbide coatings indicated that at the wear rates predicted by the CFD model, the suction liner comprising treated surfaces 22A, 22B and 22C would remain operationally capable for at least six times longer than the untreated suction liner used within the same service class and produced with conventional materials known to practitioners having ordinary skill in the art.

TABLE 2
Predicted Wear Events and Protective Coating
Protocol in Surry Pump Casing Liner

| | See | Predicted | | Coating Thickness |
|---|---|---|---|---|
| Surface | FIG. | Wear Event(s) | Coating(s) | Prescribed |
| 20A | FIG. 5 | Erosion | silicone | 500-1500μ |
| | | | WC | 350-2500μ |
| 20B | FIG. 6 | Erosion | silicone | 500-1500μ |
| | | | WC | 350-2500μ |
| 20C | FIG. 7 | Erosion | silicone | 500-1500μ |
| | | | WC | 350-2500μ |
| 20D | FIG. 8 | Erosion | silicone | 500-1500μ |
| | | | WC | 350-2500μ |
| 22E | FIG. 9 | Erosion & | WC | 350-2500μ |
| | | Abrasion | | |

Laboratory results employing test coupons treated with the silicone and tungsten carbide coatings indicated that at the wear rates predicted by the CFD model, the casing liner comprising treated surfaces 20A (cut water), 20B (semi-volute top), 20C (semi-volute bottom), 20D (nozzle), and 20E (back surface) would remain operationally capable at least two times longer than the untreated slurry pump casing liner used within the same service class and produced with conventional materials known to practitioners having ordinary skill in the art.

TABLE 3
Predicted Wear Events and Protective Coating Protocol
in Surry Pump Impeller (Surfaces 24A-24E)

| | See | Predicted | | Coating Thickness |
|---|---|---|---|---|
| Surface | FIG. | Wear Event(s) | Coating(s) | Prescribed |
| 24A | FIG. 10 | Erosion | silicone | 500-1500μ |
| 24B | FIG. 11 | Erosion | silicone | 500-1500μ |
| 24C | FIG. 12 | Erosion | silicone | 500-1500μ |
| | | | WC | 350-2500μ |
| 24D | FIG. 13 | Erosion & | WC | 350-2500μ |
| | | Abrasion | | |
| 24E | FIG. 14 | Erosion | silicone | 500-1500μ |
| | | | WC | 350-2500μ |

Laboratory results employing test coupons treated with the silicone and tungsten carbide coatings indicated that at the wear rates predicted by the CFD model, the slurry pump impeller comprising treated surfaces 24A (internal blade), 24B (internal disk), 24C (external disk), 24D (external blade), and 24E (external blade flank) would remain operationally capable at least 6 times longer than the untreated impeller used within the same service class and produced with conventional materials known to practitioners having ordinary skill in the art.

TABLE 4
Predicted Wear Events and Protective Coating Protocol
in Surry Pump Impeller (Surfaces 24F-24J)

| | See | Predicted | | Coating Thickness |
|---|---|---|---|---|
| Surface | FIG. | Wear Event(s) | Coating(s) | Prescribed |
| 24F | FIG. 15 | Erosion & | WC | 350-2500μ |
| | | Abrasion | | |
| 24G | FIG. 16 | Erosion | silicone | 500-1500μ |
| | | | WC | 350-2500μ |
| 24H | FIG. 17 | Erosion & | WC | 350-2500μ |
| | | Abrasion | | |
| 24I | FIG. 18 | Erosion & | WC | 350-2500μ |
| | | Abrasion | | |
| 24J | FIG. 19 | Erosion | silicone | 500-1500μ |
| | | | WC | 350-2500μ |

Laboratory results employing test coupons treated with the silicone and tungsten carbide coatings indicated that at the wear rates predicted by the CFD model, the slurry pump impeller comprising treated surfaces 24F (eye adjacent to suction liner), 24G (hub inner side), 24H (hub adjacent to casing liner), 24I (hub adjacent to packing seal), and 24J (outer diameter) would remain operationally capable at least six times longer than the untreated impeller used within the same service class and produced with conventional materials known to practitioners having ordinary skill in the art.

The foregoing examples are merely illustrative, serving to illustrate only some of the features of the invention. The appended claims are intended to claim the invention as broadly as it has been conceived and the examples herein presented are illustrative of selected embodiments from a manifold of all possible embodiments. Accordingly, it is Applicants' intention that the appended claims are not to be limited by the choice of examples utilized to illustrate features of the present invention. As used in the claims, the word “comprises” and its grammatical variants logically also subtend and include phrases of varying and differing extent such as for example, but not limited thereto, “consisting essentially of” and “consisting of.” Where necessary, ranges have been supplied, those ranges are inclusive of all sub-ranges there between. It is to be expected that variations in these ranges will suggest themselves to a practitioner having ordinary skill in the art and where not already dedicated to the public, those variations should where possible be construed to be covered by the appended claims. It is also anticipated that advances in science and technology will make equivalents and substitutions possible that are not now contemplated by reason of the imprecision of language and these variations should also be construed where possible to be covered by the appended claims.

In the preceding specification and the claims, which follow, reference may be made to a number of terms, which shall be defined to have the following meanings.

As used herein, the terms equipment and apparatus may be used interchangeably and have the same meaning.

The singular forms “a”, “an”, and “the” include plural referents unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about” and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

1. A method of protecting slurry handling equipment, the method comprising:
(a) identifying one or more types of wear events to which an internal surface of the slurry handling equipment is susceptible during operation;
(b) estimating the severity of each type of wear event the surface will experience during operation; and
(c) applying one or more of a thermal spray coating comprising a metal carbide or a metal nitride, and an erosion resistant organic coating to the surface;
wherein the types and severity of the wear events are predicted using one or more computational fluid dynamics models, and
wherein the applying of either or both of the thermal spray coating and the erosion resistant organic coating to the surface is predicated on the types of wear events identified and their estimated severity.

2. The method according to claim 1, wherein the slurry handling equipment is selected from the group consisting of pumps, compressors, fans, expanders, turbines, and valves.

3. The method according to claim 1, wherein the slurry handling equipment is a slurry handling pump.

4. The method according to claim 3, wherein the slurry handling pump comprises a plurality of internal surfaces susceptible to at least one wear event selected from the group consisting of erosion, abrasion, and corrosion.

5. The method according to claim 4, wherein the slurry handling pump comprises at least one internal surface susceptible to erosion and at least one surface susceptible to abrasion.

6. The method according to claim 5, wherein the one or more inputs to the computational fluid dynamics model includes as characteristics of a slurry being handled by the slurry handling pump, one or more of a slurry particle size distribution, a slurry particle density, and a slurry particle hardness.

7. The method according to claim 6, wherein the thermal spray coating comprises a metal carbide discontinuous phase and a metal alloy continuous phase.

8. The method according to claim 7, wherein the metal carbide is selected from the group consisting of titanium carbide, zirconium carbide, hafnium carbide, vanadium carbide, niobium carbide, tantalum carbide, chromium carbide, molybdenum carbide, tungsten carbide, silicon carbide, boron carbide and combinations of two or more of the foregoing metal carbides.

9. The method according to claim 7, wherein the continuous phase comprises one or more of cobalt, chromium, molybdenum, copper, nickel, vanadium, and carbon.

10. The method according to claim 6, wherein the erosion resistant organic coating comprises one or more materials selected from silicone rubbers, polyurethanes, polyepoxides, phenolic resins, and combinations of two or more of the foregoing material types.

11. The method according to claim 10, wherein the erosion resistant coating comprises a silicone rubber and an inorganic filler.

12. A method of protecting slurry handling equipment, the method comprising:
applying one or more of a thermal spray coating comprising a metal carbide or a metal nitride, and an erosion resistant organic coating to one or more internal surfaces of the slurry handling equipment;
wherein the one or more internal surfaces selected for protection have been identified as surfaces susceptible to one or more wear events during operation using one or more computational fluid dynamics models, and
wherein the applying of either or both of the thermal spray coating and the erosion resistant organic coating to the one or more internal surfaces is predicated on the types of wear events identified and the estimated severity of such wear events as predicted by the one or more computational fluid dynamics models, and
wherein a thickness of the thermal spray coating and a thickness of the erosion resistant organic coating required to provide a significant level of protection to the surface with respect to each wear event identified is predicted using the one or more computational fluid dynamics models.

13. A slurry handling pump comprising:
(a) one or more internal surfaces susceptible to erosion wear events and one or more internal surfaces susceptible to abrasion wear events; and
(b) one or more protective coatings substantially covering each surface susceptible to erosion wear events and each surface susceptible to abrasion wear events, said protective coatings being selected from one or more of a thermal spray coating comprising a metal carbide or a metal nitride, and an erosion resistant organic coating;
wherein the surfaces selected for protection have been identified as surfaces susceptible to erosion wear events and surfaces susceptible to abrasion wear events using one or more computational fluid dynamics models, and
wherein the protective coatings are selected based on a predicted type and severity of the wear event identified by the one or more computational fluid dynamics models.

14. The slurry handling pump according to claim 13, wherein the thermal spray coating comprises a metal carbide discontinuous phase and a metal alloy continuous phase

15. The slurry handling pump according to claim 14, wherein the metal carbide is selected from the group consisting of titanium carbide, zirconium carbide, hafnium carbide, vanadium carbide, niobium carbide, tantalum carbide, chromium carbide, molybdenum carbide, tungsten carbide, silicon carbide, boron carbide and combinations of two or more of the foregoing metal carbides.

16. The slurry handling pump according to claim 15, wherein the continuous phase comprises one or more of cobalt, chromium, molybdenum, copper, nickel, vanadium, and carbon.

17. The slurry handling pump according to claim 16, wherein the erosion resistant organic coating comprises one or more materials selected from silicone rubbers, polyurethanes, polyepoxides, phenolic resins, and a combinations of two or more of the foregoing material types.

18. A slurry handling apparatus comprising:
(a) at least one internal surface susceptible to erosion wear events and at least one internal surface susceptible to abrasion wear events; and
(b) a plurality of protective coatings substantially covering each surface susceptible to erosion wear events and each surface susceptible to abrasion wear events, said protective coatings being selected from one or more of a thermal spray coating comprising a metal carbide or a metal nitride, and an erosion resistant organic coating;
wherein the surfaces selected for protection have been identified as surfaces susceptible to erosion wear events and surfaces susceptible to abrasion wear events using one or more computational fluid dynamics models, and
wherein the protective coatings are selected based on a predicted type and severity of the wear event identified by the one or more computational fluid dynamics models.

19. The slurry handling apparatus according to claim 18, which is selected from the group consisting of slurry handling pumps, slurry handling compressors, slurry handling fans, slurry handling expanders, slurry handling turbines, and slurry handling valves.

20. A slurry handling apparatus component comprising:
(a) at least one component surface configured to constitute an internal surface of a slurry handling apparatus susceptible to one or more wear events selected from the group consisting of erosion, and abrasion; and
(b) one or more protective coatings substantially covering each component surface susceptible to said wear events, said protective coatings being selected from one or more of a thermal spray coating comprising a metal carbide or a metal nitride, and an erosion resistant organic coating;
wherein the component surface selected for protection has been identified as a surface susceptible to said wear events using one or more computational fluid dynamics models,
wherein the protective coatings are selected based on the type of wear event identified by the one or more computational fluid dynamics models, and
wherein the estimated severity of such wear event is predicted by the one or more computational fluid dynamics models.

21. The slurry handling apparatus component according to claim 20, which is selected from the group consisting of casings, liners, blades, vanes, conduits, inlets, outlets, impellers, drive shafts, and valves.

22. The slurry handling apparatus component according to claim 20, wherein the one or more protective coatings comprises an erosion resistant silicone elastomer.

23. The slurry handling apparatus component according to claim 20, wherein the one or more protective coatings comprises a thermal spray coating comprising a metal carbide or a metal nitride.

24. The slurry handling apparatus component according to claim 20, wherein the one or more protective coatings comprises an erosion resistant organic coating and thermal spray coating comprising a metal carbide or a metal nitride.
